(19) United States
(12) Patent Application Publication
(10) Pub. No.: US 2014/0380227 A1
(43) Pub. Date: Dec. 25, 2014

(54) CONVERTIBLE COMPUTING DEVICE

(71) Applicants: Kar Mun Ng, Shanghai (CN); Sameer Kp, Bangalore (IN)

(72) Inventors: Kar Mun Ng, Shanghai (CN); Sameer Kp, Bangalore (IN)

(21) Appl. No.: 13/976,730

(22) PCT Filed: Dec. 28, 2012
(86) PCT No.: PCT/CN2012/087827

§ 371 Date: Jun. 27, 2013

(51) Int. Cl. G06F 3/0488; G06F 3/0484

(52) U.S. Cl. CPC G06F 3/0488; G06F 3/04842
USPC 715/778

(57) ABSTRACT

A computing device including logic at least partially comprising hardware logic to set display modes is disclosed. The logic may be configured to determine if the computing device is closed, and, if so, set the computing device to a single tablet display mode in which the computing device is to render a tablet interface at a first display panel. The logic may be configured to determine if the computing device is open, and, if so, set one of two display modes comprising: a dual tablet display mode in which the computing device is to render a tablet interface at the first display panel and a second display panel; or a laptop mode in which the computing device is to render content at the first display panel and the second display panel is to receive input via a virtual input device.

### TECHNICAL FIELD

The present disclosure generally relates to techniques for setting display and interaction modes at a computing device. Specifically, the present disclosure relates to setting display and interaction modes at computing device when the computing device is open or closed.

### BACKGROUND ART

With the proliferation of electronic devices, including computing devices, communication devices, and portable entertainment devices, many types of hybrid devices that combine computing, communication, and/or entertainment functions have been developed. One class of hybrid device is the so-called convertible tablet device that can operate and display in a “notebook” mode and in a tablet mode. These devices typically have the form factor of a laptop computer and typically include a display panel that is connected to an input panel that includes a full keypad (QWERTY) and mouse functionality.

In the laptop mode, the display panel and keypad are thus typically oriented similarly to a conventional laptop computer, where the display panel can be set at a convenient viewing angle with respect to the input panel and the keyboard is used to control information presented on the display panel. In order to operate in a tablet mode, such convertible tablet devices provide complex conversion mechanisms between the display panel and input panel that allow the display panel and input panel to stack together to form a flat tablet-like device where the display faces outwardly. In the tablet mode of operation, the display surface provides a user interface to receive input as in conventional tablet devices.

### BRIEF DESCRIPTION OF THE DRAWINGS

FIG. 1 is a block diagram illustrating a computing device with a first display panel and a second display panel.

FIGS. 2A-2B each depict operations of are embodiment he computing device.

FIG. 3 illustrates the computing device arranged in a single tablet display mode.

FIG. 4 illustrates a computing device arranged in the dual tablet display mode.

FIG. 5 illustrates a filtering layer including two or more electric chromic filtering layers coupled to each other on the first display panel.

FIG. 6 is a table illustrating longer switch times of an electric chromic filtering layer compared to a liquid crystal filtering layer or a suspended particle filtering layer.

FIG. 7 is a block diagram illustrating a method for setting display modes.

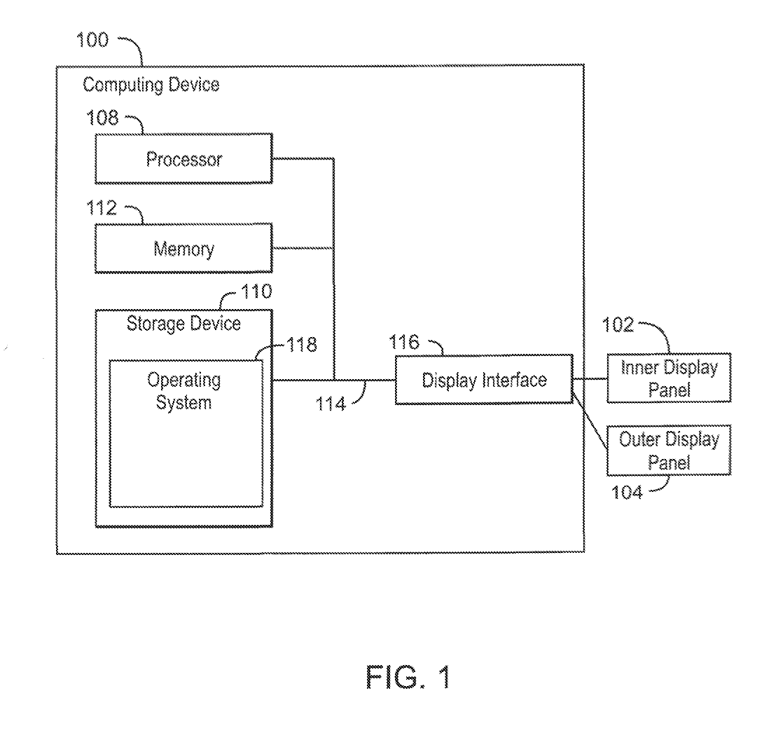

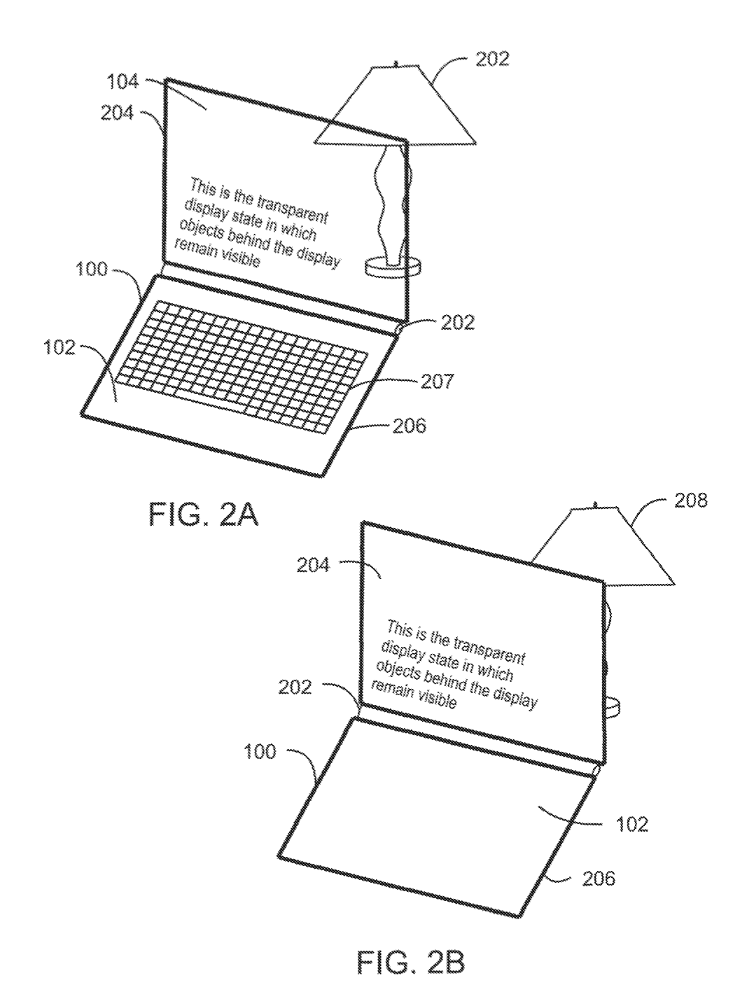

The same numbers are used throughout the disclosure and the figures to reference like components and features. Numbers in the 100 series refer to features originally found in FIG. 1; numbers in the 104 series refer to features originally found in FIG. 2; and so on.

### DESCRIPTION OF THE EMBODIMENTS

The present disclosure describes techniques for setting modes of display for a computing device. Various embodiments involve a convertible computing device, or convertible tablet device. The term “convertible tablet” as used herein, refers to an electronic device that can be used in at least three different modes, a “single tablet display mode,” a “dual tablet display mode,” and a “laptop mode.” The convertible tablet device may have two panels, such that in the single tablet display mode the two panels are disposed in a stack on top of one another. In the single tablet display mode, a display panel facing outwardly when the device is closed may provide touch screen functionality as found in conventional tablets. In the laptop mode, the two panels may be arranged in an “open clamshell” configuration that is typical of a portable computer, such as a notebook, laptop, or other flat screen portable device. In the laptop mode, a second display panel may be used as an input touch screen such as a virtual keyboard. in dual tablet display mode, the second display panel may provide touch screen functionality and operate as a tablet, and a first display panel may provide touch screen functionality as well.

FIG. 1 is a block diagram illustrating a computing device 100 with a second display panel 102 and a first display panel 104. The second display panel 102 and the first display panel 104 may be configured to render and display information. The computing device 100 may configured to function as a laptop computer, a notebook computer, a tablet computer, mobile device, among others. The computing device 100 may also include a processor 108 and a storage device 110 comprising a non-transitory computer-readable medium. As used herein, “a non-transitory computer-readable medium” is a physical storage medium for computer readable instructions that can include random access memory (RAM), read only memory (ROM), a hard drive, a RAM drive, an optical storage system, and the like.

The storage device 110 may have instructions stored thereon that when executed by the processor 108 cause the computing device 100 to perform operations. The operations may include determining if the computing device 100 is closed, and, if so, setting the computing device 100 to a single tablet display mode. Hardware logic at least partially includes hardware, and may also include software, or firmware. Hardware logic may include electronic hardware including interconnected electronic components which perform analog or logic operations on received and locally stored information to produce as output or store resulting new information or to provide control for output actuator mechanisms. Electronic hardware may include individual chips/circuits and distributed information processing systems.

“Single table display mode,” as referred to herein, is a functional mode of operation wherein a computing device that includes the first display panel and the second display panel, is to render a tablet interface to be displayed at the first display panel and darkens, or turns off, the second display panel. The operations may also include determining if the computing device 100 is open, and if so, setting one of two display modes comprising a dual tablet display mode or a laptop mode. “Laptop mode,” as referred to herein, is a functional mode of display and operation wherein a computing device, having a first display panel and second display panel, renders content at a first display panel, and receives input via a virtual input device rendered at the second display panel. “Dual tablet display mode,” as referred to herein, is a functional mode of operation wherein the computing device, including the first display panel and the second display panel, renders the tablet interface to be displayed at both the first display panel and the second display panel. The content displayed on each display panel may be the same or may be individually set for each user.

The computing device 100 may also include an operating system 118 stored in the storage device 110. The operating system may facilitate switching between display modes, such as from laptop mode to single tablet display mode or dual tablet display mode. In some embodiments, determining which display mode to set is determined by input from a user of the computing device 100. In other embodiments, determining which display mode to set is determined by detecting an application on the computing device 100 that indicates which display mode to select. For example, the computing device 100 may be running a multi-player game indicating the selection of the dual tablet display mode. As another example, the computing device 100 may be running an application optimized for a tablet interface, and the application may indicate the selection of either the single or dual tablet display mode. The computing device 100 may also include a locking mechanism (not shown) to enable the display mode to be locked by a user. The locking mechanism may be comprised of a software module, a hardware mechanism, or any combination of a software module and a hardware mechanism.

The processor 108 may be adapted to execute stored instructions from a memory device 11. The processor 8 can be a single core processor, a multi-core processor, a computing cluster, or any number of other configurations. The main processor 108 may be implemented as Complex Instruction Set Computer (CISC) or Reduced Instruction Set Computer (RISC) processors, x86 Instruction set compatible processors, multi-core, or any other microprocessor or central processing unit (CPU).

The memory device 11 may include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. In an embodiment, the instructions stored in the storage device 110 are retrieved by the processor 108 over a system bus 114 and stored in the memory device 11.

The main processor 10 may be connected through the system bus 114 (e.g., PCI, ISA, PCI-Express, HyperTransport®, NuBus, etc.) to a display interface 116. The display interface 116 may be adapted to connect the computing device 100 to the second display panel 102 and the first display panel 104.

Either of the second display panel 102, the first display panel 104, or both may include a touch screen. In the single tablet display mode, the touch screen may enable a user to interface with the computing device 100. Likewise, in dual tablet display mode, the touch screen at each of the second and first display panels 102 and 104 may enable the user to interact directly with objects displayed.

FIGS. 2A-2B each depicts operations of an embodiment of the computing device 100. The computing device 100 is arranged in a “clamshell” structure in which the second display panel 102 is coupled to the first display panel 104 by a hinge 202. As illustrated in FIG. 2, the computing device 100 is operating in the laptop mode in which the second display panel 102 may function as a virtual input device, and the first display panel 104 may function as a display, in laptop mode, the computing device 108 may render content at the first display panel 104, and receive input via a virtual input device, such as a virtual keyboard 207, rendered at the second display panel 102. The computing device 100 may include a lid 204 and a base 206. The second display panel 102 is disposed within the base 110 and the first display panel 104 is disposed at least partially within the lid 108.

In some embodiments, the first display panel 104 may be substantially transparent. For example, some organic light emitting diode (OLED) panels may be substantially transparent. As used herein, “substantially transparent” indicates that the display panel allows objects on the other side to be seen. The objects may not be clear, or may only be clearly seen when in close proximity to the display panel, e.g., contact clarity. As shown in FIG. 2, the first display panel 104 is transparent to visible light. When the computing device 100 is operated in the laptop mode, and the first display panel 104 is operated in a transparent state, a user may view information rendered on the first display panel 104, while also being able to view objects behind the first display panel 104, such as a lamp 208.

In some embodiments, the second display panel 102 s a liquid crystal display panel. In other embodiments, the second display panel 102 is an OLED panel. In either embodiment, the second display panel 102 is configured to display a virtual input device when the device is in the notebook display mode.

The first display panel 104 may include a filtering layer to adjust levels of transparency of the first display panel 104. As illustrated in FIG. 2B, the computing device 100 may operate in the laptop mode wherein the filtering layer may adjust the transparency of the first display panel 104. In the scenario depicted in FIG. 2B, the first display panel 104 is operated in an opaque state in which visible light does not transmit through the display panel 104. Thus, objects such as the lamp 208, may be obscured from the view through the first display panel 104 of the computing device 100.

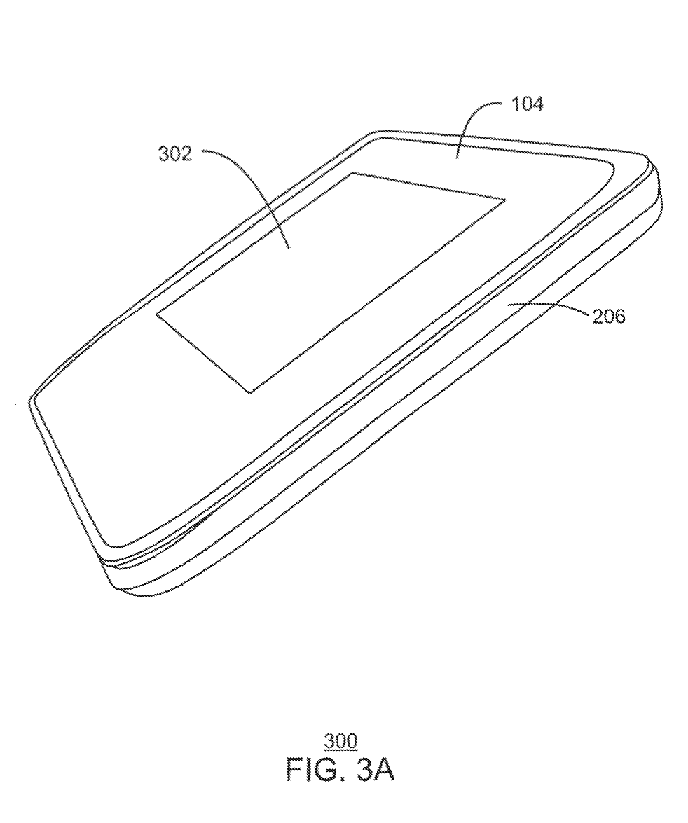

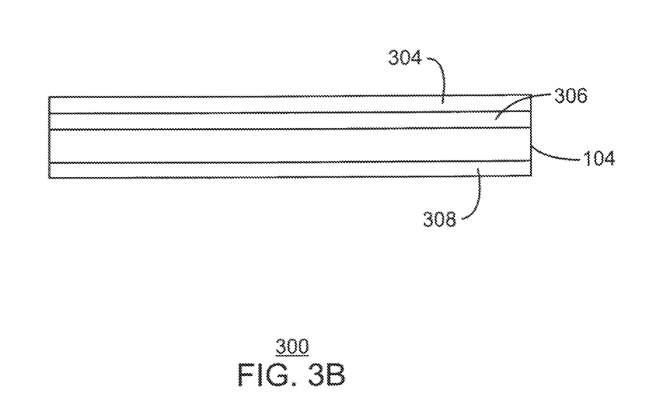

FIG. 3A illustrates the computing device 100 arranged in the single tablet display mode. As explained above, in the single tablet mode the computing device 00 may render a tablet interface 302 to be displayed at the first display panel 104 and darkens, or turns off, the second display panel (not shown) disposed within the base 206. When operating the computing device 100 in the single tablet mode, the first display panel 104 may be substantially transparent, and a keyboard may present a distraction to the user of the computing device 100. The inner panel may be turned off such that, the virtual input device, such as the virtual keyboard 207, is not visible through the first display panel 104.

FIG. 3B is a cross sectional view of the outer display having a touch panel 304 and filtering layers 306, 308. In some embodiments, a first filtering layer 306 is included at an outward facing side of the first display panel 104. The first filtering layer 306 may be activated to become opaque and reduce transparency when in the laptop mode. In other embodiments, a second filtering layer 308 is included at the inner side of first display panel 104 that may be activated to reduce transparency when in the single tablet mode or the dual tablet mode. The second filtering layer 308 may be configured to mitigate the distraction of the second display panel 102 which may be visible through the first display panel 104, and to facilitate enhanced viewing quality.

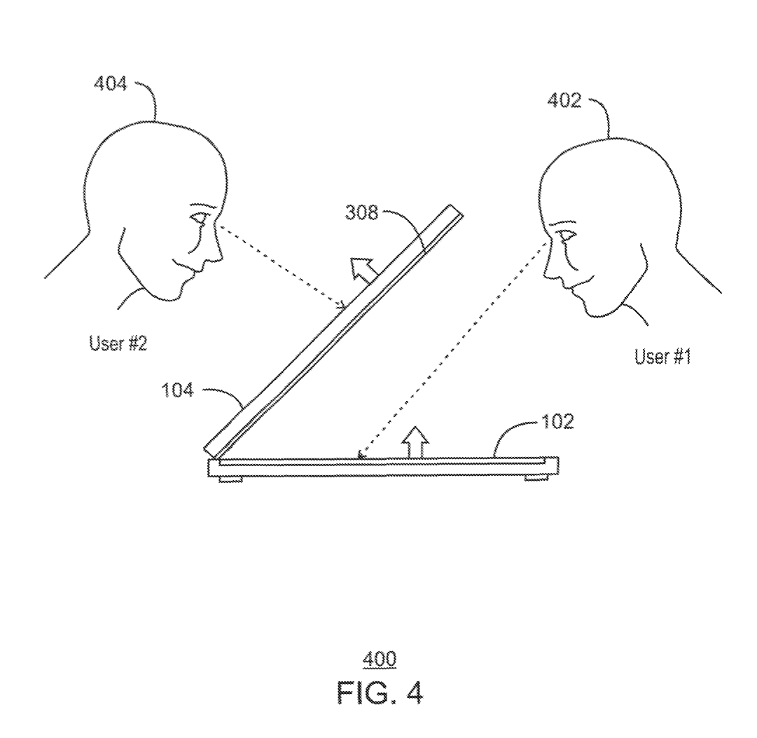

FIG. 4 illustrates the computing device 100 arranged in the dual tablet display mode. As explained above, in the dual tablet display mode the first display panel 104 and the second display panel 102 may render the same tablet interface to be displayed at both the first display panel 104 and the second display panel 102. In contrast to the laptop mode, where the second display panel 102 renders a virtual input device such as a virtual keyboard, the second display panel 102 renders the tablet interface, such as the tablet interface 302 discussed in reference to in FIG. 3 above. The dual tablet display mode may facilitate a first user 402 and a second user 404 to view and interact with the computing device 100 in a simultaneous manner, such as during multiplayer gaming, content sharing, and the like.

As discussed above in reference to FIGS. 2B and 3B, the computing device may include a first filtering layer 306 and a second filtering layer 308 at the first display panel 104. Either of the first filtering layer 306 or the second filtering layer 308 may comprise one of: an electrochromic laminate layer comprising two or more electrochromic laminate pieces coupled to each other, a liquid crystal laminate layer, or a suspended particle laminate layer. Each of the first filtering layer 306 or the second filtering layer 308 may be configured to adjust levels of transparency at the first display panel 104. When the computing device 100 is in the dual tablet display mode, the second filtering layer 308 may obscure the transparency at an inner side of the first display panel 104, by reducing the transparency level at an inner side of the first display panel 104. The inner side is the side adjacent to, or facing the second display panel 102. The reduced transparency may facilitate viewing the computing device 100 by both the first user 402 and the second 404 simultaneously without distraction from renderings on one or another of the display panels.

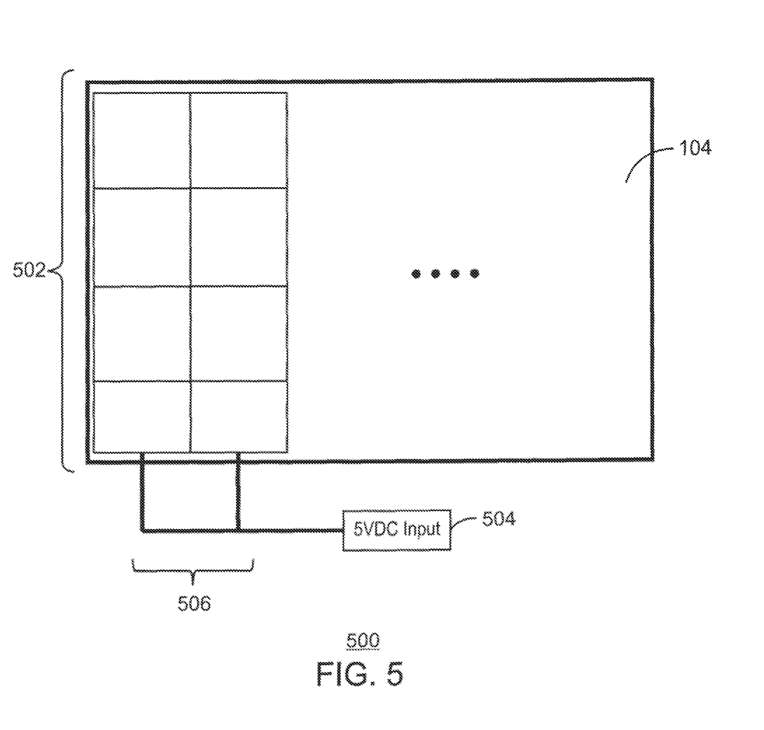

FIG. 5. Illustrates a filtering layer including two or more electrochromic filtering layers 602 coupled to each other at the first display panel 104. Two or more electrochromic filtering layers may be electrically coupled to each other, and to a power source 504. The power source 504 may be a 5 Volt direct current power source, and may provide power to the two or more filtering layers 502 in parallel as indicated by the bracket 506. In embodiments, the two or more chromic filtering layers 502 may facilitate a relatively faster switching speed and less power consumption in comparison to a filtering layer comprising a single electrochromic filtering layer.

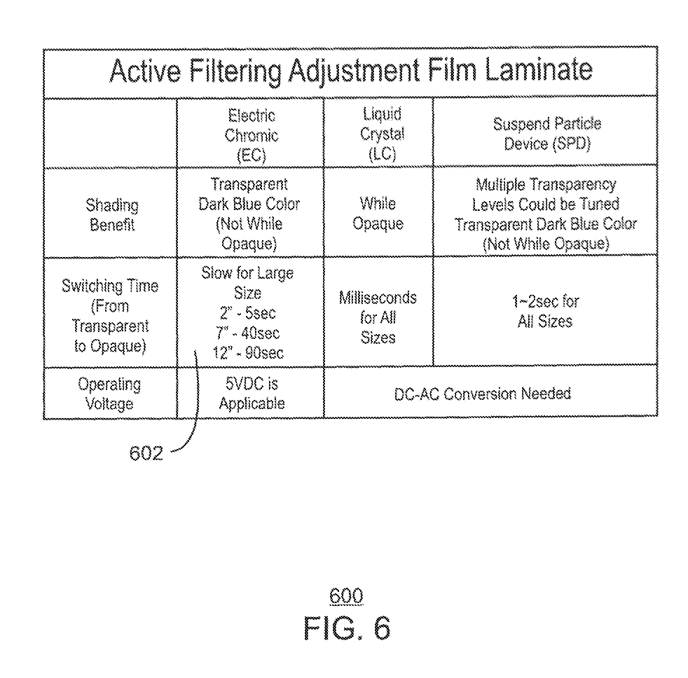

FIG. 6 is a table 600 illustrating longer switch times of an electrochromic filtering layer compared to a liquid crystal filtering layer or a suspended particle filtering layer. A “suspended particle filtering layer,” as referred to herein, is a thin film laminate of rod-like particles suspended in a fluid is placed between two layers, or attached to one layer. When no voltage is applied, the suspended particles are arranged in random orientations and tend to absorb light, so that the glass panel is opaque. When voltage is applied, the suspended particles align and let light pass. For example, the switch times for electrochromic filtering layers decreases with the size of the electrochromic filtering layer piece as illustrated at block 602. In some embodiments, a filtering layer comprising electrochromic layer pieces may include smaller pieces, such as 2″ pieces that are coupled to each other. In other embodiments, the filtering layer may comprise either liquid crystal or the suspended particle filtering layers.

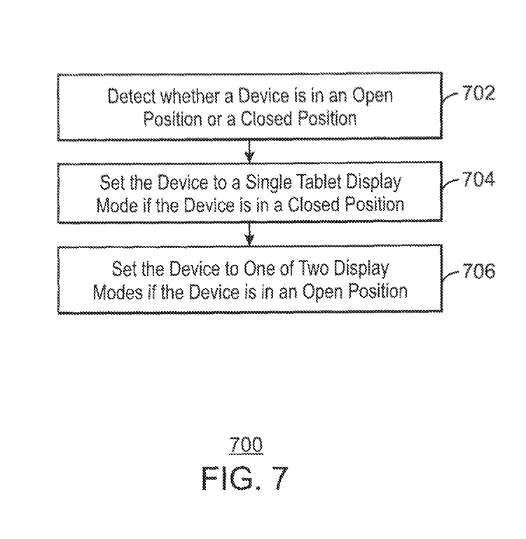

FIG. 7 is a block diagram illustrating a method 700 for setting display modes. The method 700 may include, at block 702, detecting whether a computing device is in an open position or a closed position. The method 700 may also include, at block 704, setting the computing device to the single tablet display mode if the device is in the closed position. The method 700 may include, at block 706, setting the device to one of two display modes if the device is the open position.

The device may be set, at block 704, to the single tablet display mode in which the computing device renders a tablet interface to be displayed at a first display panel when the device is closed. When the device is open, the display modes may be set, at block 706, to either the dual tablet display mode or the laptop mode discussed above. Specifically, the dual tablet display mode may render the same tablet interface as was rendered in the single tablet display mode at both the first display panel and a second display panel. Alternatively, the dual tablet display mode may render a different tablet interface for each display panel. The laptop mode renders content at the first display panel and use the second display panel as a virtual input device.

In some embodiments, determining a display mode to set when the device is open is determined by input from a user of the device. In other embodiments, determining which display mode to set is in response to an application. For example, when the device is open, the display mode selected is determined by detecting an application running on the computing device that indicates which display mode to select.

The first display panel may be an OLED panel that is substantially transparent. The second display panel may be either an OLED panel or a liquid crystal display panel. In some embodiments, the second display panel may be substantially transparent. The outer panel may include a filtering layer configured to adjust levels of transparency of the first display panel The method 700 may include reducing the level of transparency of the filtering layer when the computing device is set to the dual display mode. Each of the outer and second display panel may include touch screen functionality. The single tablet display mode or the dual tablet display mode may enable the use to interact with the touch screen on the respective panel. Similarly, the laptop mode may enable the user to interact with the virtual input device via the touch screen on the second display panel, or with the display at the first display panel.

Some embodiments may be implemented in one or a combination of hardware, firmware, and software. Some embodiments may also be implemented as instructions stored on the tangible non-transitory machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM): magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described it reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A computing device, comprising logic at least partially comprising hardware logic to:
determine if the computing device is closed, and, if so, set the computing deice to a single tablet display mode in which the computing device is to render a tablet interface at a first display panel; and
determine if the computing device is open, and, if so,
set one of two display modes comprising:
a dual tablet display mode in which the computing device is to render a tablet interface at the first display panel and a second display panel; or
a laptop mode in which the computing device is to render content at the first display panel and the second display panel is to receive input via a virtual input device.

2. The computing device of claim 1, wherein an outer side of the first display panel is viewable when the computing device is closed, and the second display panel is coupled to the first display panel by a hinge.

3. The computing device of claim 1, wherein the logic o seta display mode in response to input from a user of the computing device.

4. The computing device of claim 1, wherein the logic is to set a display mode in response to detection of an application.

5. The computing device of claim 1, wherein the first display panel is an organic light emitting diode (OLED) panel that is substantially transparent.

6. The computing device of claim 5, further comprising a filtering layer at the first display panel, the filtering layer to adjust a level of transparency of the first display panel, the filtering layer comprising one of:
an electrochromic laminate layer comprising two or more electrochromic laminate pieces electrically coupled to each other;
a liquid crystal laminate layer; or
a suspended particle laminate layer.

7. The computing device of claim 5, further comprising logic at least partially comprising hardware logic to reduce a transparency level at a filtering layer at an inner of the first display panel for the dual tablet display mode.

8. The computing device of claim 1, wherein the logic is to render a different tablet interface at each of the first display panel and the second display panel for the dual tablet display mode.

9. The computing device of claim 1, wherein the logic is to render a similar tablet interface at each of the first display panel and the second display panel for the dual tablet display mode.

10. A computing device, comprising:
a lid;
a base coupled to the lid by a hinge;
a first display panel disposed at least partially within the lid of the computing device, the first display panel to render data in either a laptop display mode when the lid is open, a dual tablet display mode when the lid is open, or a single tablet display mode when the lid is closed; and
a second display panel disposed at least partially within the base of the computing device, the second display panel to render data in a laptop display mode wherein the second display panel is arranged as a peripheral input device and the first second display panel is arranged as a display device, or in a dual tablet display mode wherein both the first display panel and the second display panel are arranged as a tablet interface.

11. The computing device of claim 10, comprising logic at least partially comprising hardware logic to:
set the computing device to the single tablet display mode when the lid is closed;
determine a display mode to set when the lid is open; and
set the computing device to one of the dual tablet display mode or the laptop display mode when the lid is open.

12. The computing device of claim 11, wherein the logic is to render a different tablet interface at each of the first display panel and the second display panel for the dual tablet display mode.

13. The computing device of claim 11, wherein the logic is to render a similar tablet interface at each of the first display panel and the second display panel for the dual tablet display mode.

14. The computing device of claim 11, the logic comprising an input module to receive input from a user to determine which display mode to set.

15. The computing device of claim 11, the logic comprising a detection module to detect an application to determine which display mode to set.

16. The computing device of claim 10, wherein the first display panel is an organic light emitting diode (OLEO) panel that is substantially transparent.

17. The computing device of claim 16, further comprising a filtering layer at the first display panel, the filtering layer to adjust a level of transparency at the first display panel, the filtering layer comprising one of:
an electrochromic laminate layer comprising two or more electrochromic laminate pieces electrically coupled to each other;
a liquid crystal laminate layer; or
a suspended particle laminate layer.

18. The computing device of claim 16, comprising logic at least partially comprising hardware logic to reduce a transparency level at a filtering layer at an inner side of the first display panel for the dual tablet display mode.

19. A non transitory computer-readable medium, having instructions thereon use a computing device to perform operations, the operations comprising:
detect whether a computing device is in an open position or in a closed position; if the computing device is in the closed position,
set the computing device to a single tablet display mode in which the computing device is to render a tablet interface at a first display panel; and, if the computing device is in the open position; and
set the computing device to one of two display modes, the display modes comprising:
a dual tablet display mode in which the computing device is to render a tablet interface at the first display panel and a second display panel; or
a laptop display mode in which the computing device is to render content at the first display panel, and to use the second display panel as a virtual input device.

20. The non-transitory computer-readable medium of claim 19, the operations comprising determine a display mode in response to input from a user of a computing device.

21. The non-transitory computer-readable medium of claim 19, wherein the operations comprising determine a display mode in response to detection of an application.

22. The non-transitory computer-readable medium of claim 19, wherein the first display panel is an organic light emitting diode PLED) panel hat is substantially transparent.

23. The non-transitory computer-readable medium of claim 22, the operations comprising reducing a transparency level at a filtering layer at an inner side of the first display panel for the dual tablet display mode.

24. The non-transitory computer-readable medium of claim 19, the operations comprising render a different tablet interface at each of the first display panel and the second display panel for the dual tablet display mode.

25. The non-transitory computer-readable medium claim 19, the operations comprising render a similar tablet interface at each of the first display panel and the second display panel for the dual tablet display mode.
